(19) United States
(12) Patent Application Publication
(10) Pub. No.: US 2006/0191739 A1
(43) Pub. Date: Aug. 31, 2006

(54) Motor-driven steering assist apparatus

(75) Inventor: Shinsuke Koga, Tochigi (JP)

Correspondence Address: Orum & Roth LLC, Suite 1616, 53 W Jackson Boulevard, Chicago, IL, 60604-3606, US

(73) Assignee: SHOWA CORPORATION

(21) Appl. No.: 11/227,512

(22) Filed: Sep. 15, 2005

(30) Foreign Application Priority Data
Feb. 28, 2005 (JP) 2005-054107

(51) Int. Cl. B62D 5/04

(52) U.S. Cl. 180/446

(57) ABSTRACT

A motor-driven steering assist apparatus interposed between a steering handle and a tire wheel side steering member is disclosed for assisting a steering force applied to the steering handle by a driver on the basis of a torque generated by an electric motor. The motor-driven steering assist apparatus has an engine rotation sensor outputting a rotation signal of an engine, a torque sensor detecting a steering torque applied to the steering handle, and a control means for computing a vehicle speed on the basis of the rotation signal of the engine rotation sensor. Driving current of the electric motor is computed on the basis of the computed vehicle speed and the detected torque of the torque sensor, for assist controlling the electric motor.

### BACKGROUND OF THE INVENTION

1. Field of the Invention

The present invention relates to a motor-driven steering assist apparatus preferably mounted on a rough road traveling vehicle such as a buggy vehicle (a saddle riding type vehicle) or the like.

2. Description of the Related Art

In a motor-driven steering assist apparatus of a buggy vehicle or the like, as described in Japanese Patent No. 2663454 (patent document 1), there is a structure which is interposed between a steering handle and a tire wheel side steering member, which assists steering by a torque generated by an electric motor on the basis of a steering force applied to the steering handle by a driver.

The motor-driven steering assist apparatus described in the patent document 1 has a torque sensor which detects a steering torque applied to the steering handle, computes an assist driving current of the electric motor on the basis of the detected torque of the torque sensor, and controls the electric motor. The structure is made such that the electric motor generates the assist torque corresponding to the steering torque applied to the steering handle by the driver, so as to steer.

In a rough road traveling vehicle as described in the patent document 1, a vehicle speed sensor is not provided, and a vehicle speed is not considered at a time of computing the driving current of the electric motor generating the assist torque. However, even in a rough road traveling vehicle, as a preferable steering force for the driver, there is desired a light steering force in a low vehicle speed region, and a suitably heavy steering force capable of obtaining stability in a high vehicle speed region.

### SUMMARY OF THE INVENTION

An object of the present invention is to control an assist torque of an electric motor in such a manner as to optimize the balance of steering properties and stability in correspondence to a change in vehicle speed, and in a simple fashion obtain an optimum steering force without using a special vehicle speed sensor, in a motor-driven steering assist apparatus.

The present invention relates to a motor-driven steering assist apparatus interposed between a steering handle and a tire wheel side steering member, for assisting steering by a torque generated by an electric motor on the basis of a steering force applied to the steering handle by a driver. The invention comprises an engine rotation sensor outputting a rotation signal of an engine, and a torque sensor which detects steering torque applied to the steering handle. A control means is present for computing vehicle speed on the basis of the rotation signal of the engine rotation sensor, computing an assist driving current of the electric motor on the basis of the computed vehicle speed and the detected torque of the torque sensor, and controlling the electric motor.

### BRIEF DESCRIPTION OF THE DRAWINGS

The present invention will be more fully understood from the detailed description given below and from the accompanying drawings which should not be taken to be a limitation on the invention, but are for explanation and understanding only.

The drawings:

FIG. 1 is a control system view showing a motor-driven steering assist apparatus;

FIG. 2 is a cross sectional view showing the motor-driven steering assist apparatus;

FIG. 3 is a flow chart of a vehicle speed responding control of an assist torque by an electric motor;

FIG. 4 is a graph showing a vehicle speed control map; and

FIG. 5 is a graph showing a current control map.

### DESCRIPTION OF THE PREFERRED EMBODIMENTS

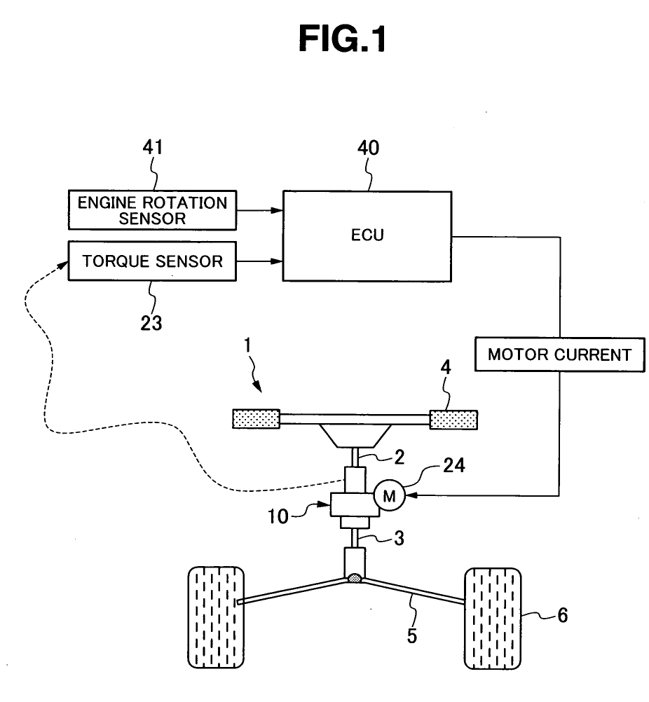

A motor-driven steering assist apparatus 10 may be applied to a rough road traveling vehicle 1, for example, a buggy vehicle, a snowmobile and the like. The apparatus is interposed between a steering wheel side steering shaft 2 and a tire wheel side steering member 3, as shown in FIG. 1, and assists steering force applied to the steering wheel 4 by a driver on the basis of a generated torque of an electric motor 24.

The vehicle 1 rotatably supports the steering shaft 2 to an upper vehicle body side stay, and is provided with the steering handle 4 in an upper end portion of the steering shaft 2. The steering member 3 is rotatably supported to a lower vehicle body side stay, and right and left front wheels 6 are connected to a pitman arm (not shown) fixed to a lower end portion of the steering member 3 via right and left tie rods 5.

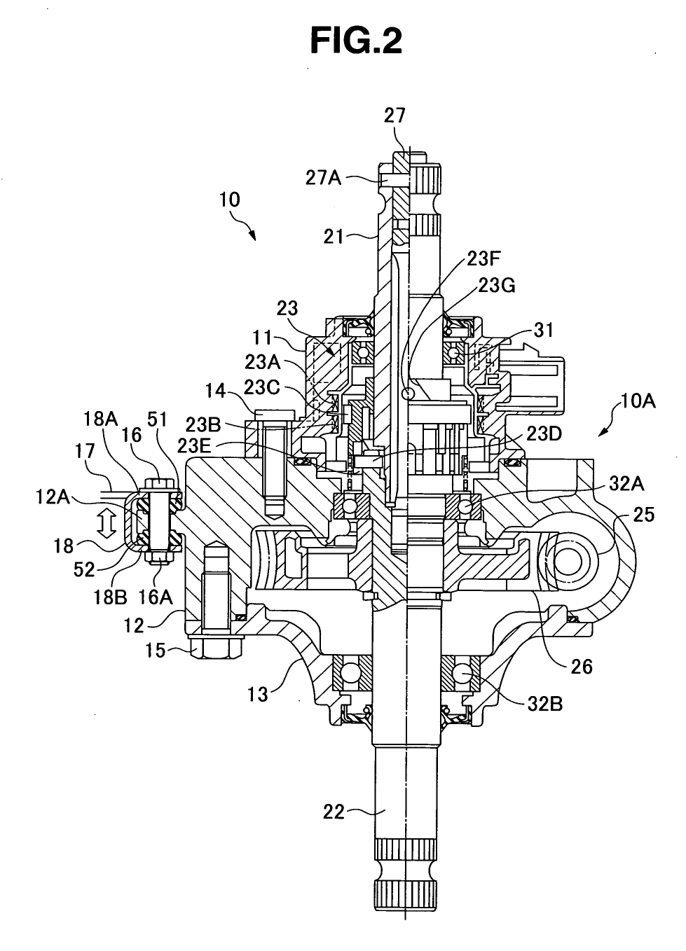

The motor-driven steering assist apparatus 10 is structured by a single unit body 10A covered by first housing 11 (upper housing or upper cover), second housing (main housing), and third housing (lower housing or lower cover) 13, as shown in FIG. 2. The unit body 10A has an input shaft 21, an output shaft 22, a torque sensor 23, an electric motor 24, a worm gear 25 and a worm wheel 26 built-in.

The motor-driven steering assist apparatus 10 is structured such that an upper end portion of the input shaft 21 to which the steering shaft 2 is connected is supported to the first housing 11 by the bearing 31. Upper and lower end portions of the output shaft 22 to which the tire wheel side steering member 3 is connected are supported to the second housing 12 and the third housing 13 by upper and lower bearings 32A and 32B. A torsion bar 27 is inserted in a hollow portion of the input shaft 21. One end of the torsion bar 27 is coupled to the input shaft 21 by a coupling pin 27A, and the other end of the torsion bar 27 is inserted in a hollow portion of the output shaft 22 so as to be connected by serration.

A torque sensor 23 is provided with two detecting coils 23A and 23B surrounding a cylindrical core 23C engaged with the input shaft 21 and the output shaft 22 in the first housing 11. The core 23C is provided with a vertical groove 23E engaging with a guide pin 23D of the output shaft 22 so as to be movable only in an axial direction, and is provided with a spiral groove 23G engaging with a slider pin 23F of the input shaft 21. Accordingly, when a steering torque applied to the steering wheel is applied to the input shaft 21, and a relative displacement in a rotation direction is generated between the input shaft 21 and the output shaft 22 on the basis of an elastic torsional deformation of the torsion bar 27, the displacement in the rotation direction of the input shaft 21 and the output shaft 22 displaces the core 23C in an axial direction. An inductance of the detecting coils 23A and 23B caused by a magnetic change around the detecting coils 23A and 23B due to the displacement of the core 23C is changed. In other words, when the core 23C moves close to the input shaft 21, the inductance of the detecting coil 23A to which the core 23C moves close is increased, and the inductance of the detecting coil 23B from which the core 23C moves apart is reduced, whereby it is possible to detect the steering torque on the basis of the change of the inductance.

The electric motor 24 is attached and supported to the second housing 12, and is driven by an electronic control unit (ECU) 40 (FIG. 1) in correspondence to the detected torque of the torque sensor 23. A worm gear 25 is coupled to a rotation shaft of the electric motor 24 by a joint, and a worm wheel 26 engaging with the worm gear 25 is fixed to the output shaft 22.

Accordingly, in the motor-driven steering assist apparatus 10, an integral unit body 10A is structured as follows. The upper end portion of the input shaft 21 and the torque sensor 23 are supported to the first housing 11. The upper end portion of the output shaft 22, the electric motor 24, the worm gear 25 and the worm wheel 26 are supported by the second housing 12. The lower end portion of the output shaft 22 is supported by the third housing 13. The first housing 11 and the second housing 12 are coupled by the mounting bolt 14, and the second housing 12 and the third housing 13 are coupled by the mounting bolt 15.

Further, the motor-driven steering assist apparatus 10 is structured such that the second housing 12 can be attached to the vehicle body side. The motor-driven steering assist apparatus 10 is structured, as shown in FIG. 2, such that elastic members 51 and 52 such as a rubber bush or the like are provided in both sides of attaching bosses 12A provided at a plurality of positions (for example, three positions) in a peripheral direction of an outer periphery of the second housing 12. The attaching bosses 12A are pinched between upper and lower support pieces 18A and 18B of forked support portions 18 provided at a plurality of positions corresponding to the attaching bosses 12A of the vehicle body side attaching stay 17 via the elastic members 51 and 52. The attaching boss 12A is pinched in a floating fixed state between the upper and lower support pieces 18A and 18B via the elastic members 51 and 52 by the support pieces 18A and 18B of the forked support portion 18, the elastic members 51 and 52, and an attaching bolt 16 (a nut 16A) inserted and attached to a bolt hole provided in each of the attaching bosses 12A. The vehicle body side bracket 17 is supported to the vehicle body frame.

Accordingly, the vehicle has an engine rotation sensor 41, and the ECU 40 has a vehicle speed response control function of the assist torque by the electric motor 24.

The engine rotation sensor 41 outputs a rotation pulse (a rotation signal) per a fixed angle of crank rotation (for example, 5 degree) of the engine, and can detect a rotating speed of the engine.

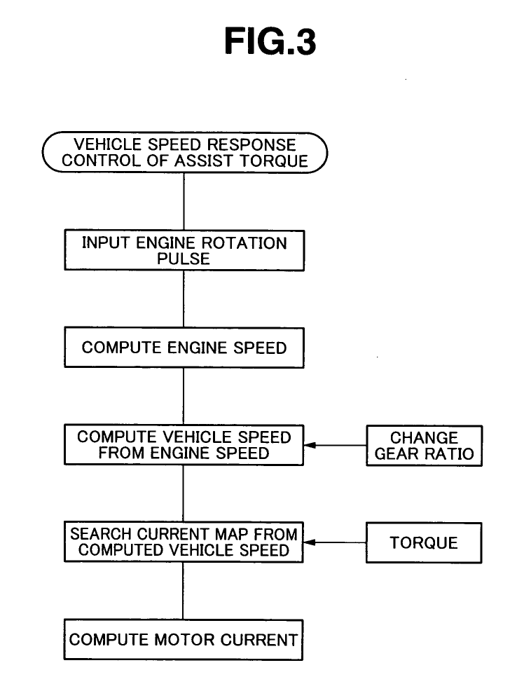

The ECU 40 repeats the following items (1) to (5) at a small time interval (some millisecond) during the engine operation of the vehicle 1, and executes the vehicle speed response control (FIG. 3).

(1) The detected rotation pulse (the rotation signal) of the engine rotation sensor 41 is input to the ECU 40.

(2) The ECU 40 computes the rotating speed of the engine on the basis of the detected rotation pulse of the engine rotation sensor 41.

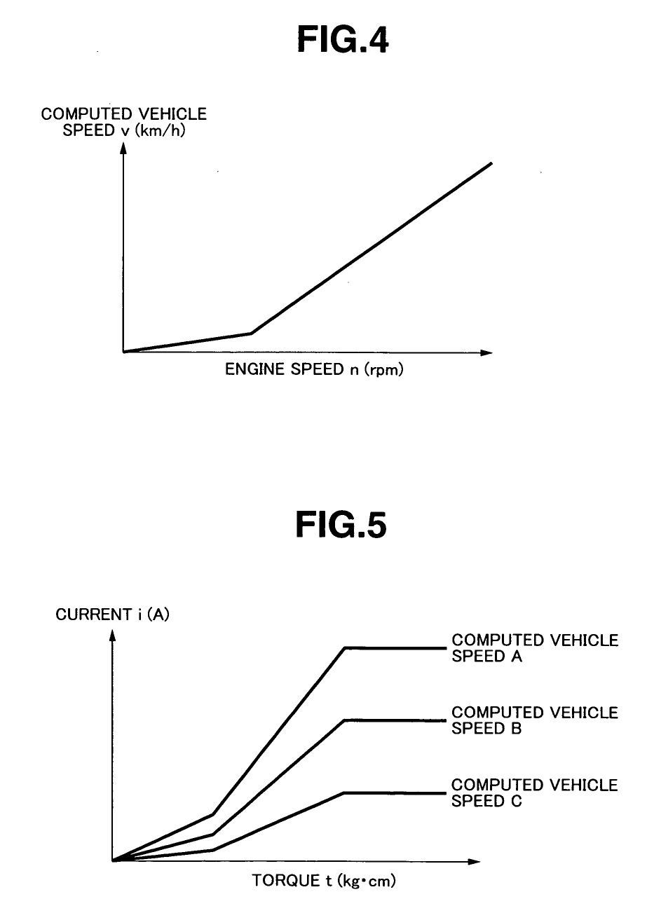

(3) The ECU 40 computes the vehicle speed on the basis of the computed rotating speed of the engine. At this time, the ECU 40 previously stores a control map (FIG. 4) defining a vehicle speed value v with respect to a rotating speed value n of the engine, applies the computed rotating speed to the control map in FIG. 4, and sets the corresponding vehicle speed to the computed vehicle speed.

When the vehicle 1 can transmit the rotation of the engine to the tire wheel by the transmission, the ECU 40 computes the vehicle speed on the basis of the computed rotating speed of the engine and the change gear ratio of the transmission. The ECU 40 may prepare the control map in FIG. 4 per the change gear ratio. When the change gear of the vehicle 1 exists at a neutral position (neutral), the change gear ratio is set to 0, and even if the engine is rotated, the vehicle speed becomes 0.

(4) The detected torque of the torque sensor 23 is input to the ECU 40.

(5) The ECU 40 computes the driving current of the electric motor 24 on the basis of the computed vehicle speed and the detected torque of the torque sensor 23, and assist controls the electric motor 24.

The ECU 40 previously stores a control map (FIG. 5) defining an optimum current value i corresponding to various combinations between a vehicle speed value v (A, B, C, . . . ) and a torque value t, applies the computed vehicle speed (for example, A) and the detected torque to the control map in FIG. 5, and sets the corresponding current to the driving current. In this case, the vehicle speed value constituting the control map in FIG. 5 may be set to multiple stages such as a low vehicle speed band region A, a middle speed band region B and a high speed band region C.

In accordance with the motor-driven steering assist apparatus 10, the vehicle speed of the vehicle 1 is computed on the basis of the detected result of the engine rotation sensor 41, the steering torque applied to the steering handle 4 by the driver is detected by the torque sensor 23, the electric motor 24 driven on the basis of the computed vehicle speed and the detected torque, and the torque generated by the electric motor 24 is transmitted to the output shaft 22 via the worm gear 25 and the worm wheel 26. Accordingly, the torque generated by the electric motor 24 is used as the assist force for the steering force applied to the steering handle by the driver.

In accordance with the present embodiment, the following operations and effects can be achieved.

(a) The ECU 40 computes the driving current of the electric motor 24 on the basis of the vehicle speed computed on the basis of the detected rotation signal of the engine rotation sensor 41 and the detected torque of the torque sensor 23, thereby controlling the assist torque of the electric motor 24. Accordingly, even in the rough road traveling vehicle 1 provided with no vehicle speed sensor, it is possible to secure the light steering force in the low vehicle speed region and the suitably heavy steering force in the high vehicle speed region. In other words, it is possible to control the assist torque of the electric motor 24 in such a manner as to optimize the balance between the steering property and the stability in correspondence to the change in the vehicle speed, and it is possible to obtain in a simple manner the optimum steering force.

(b) Since the ECU 40 computes the vehicle speed on the basis of the detected rotation signal of the engine rotation sensor 41 and the change gear ratio of the transmission, it is possible to improve the computing accuracy of the vehicle speed, and it is possible to accurately control the assist torque of the electric motor 24 in accordance with the item (a) mentioned above.

(c) The ECU 40 can simply and accurately computes the driving current of the electric motor 24 on the basis of the control map previously defining the optimum current value in correspondence to the various combinations between the vehicle speed value and the torque value.

As heretofore explained, embodiments of the present invention have been described in detail with reference to the drawings. However, the specific configurations of the present invention are not limited to the illustrated embodiments but those having a modification of the design within the range of the presently claimed invention are also included in the present invention.

Although the invention has been illustrated and described with respect to several exemplary embodiments thereof, it should be understood by those skilled in the art that the foregoing and various other changes, omissions and additions may be made to the present invention without departing from the spirit and scope thereof. Therefore, the present invention should not be understood as limited to the specific embodiment set out above, but should be understood to include all possible embodiments which can be encompassed within a scope of equivalents thereof with respect to the features set out in the appended claims.

What is claimed is:

1. A motor-driven steering assist apparatus interposed between a steering handle and a tire wheel side steering member, for assisting a steering by a torque generated by an electric motor on the basis of a steering force applied to the steering handle by a driver, comprising:
an engine rotation sensor outputting a rotation signal of an engine;
a torque sensor detecting a steering torque applied to the steering handle; and
a control means for computing a vehicle speed on the basis of the rotation signal of the engine rotation sensor, computing an assist driving current of the electric motor on the basis of the computed vehicle speed and the detected torque of the torque sensor, and controlling the electric motor.

2. A motor-driven steering assist apparatus as claimed in claim 1, wherein the rotation of the engine is transmittable to a tire wheel by a transmission, and the control means computes the vehicle speed on the basis of the detected rotation signal of the engine rotation sensor and a change gear ratio of the transmission.

3. A motor-driven steering assist apparatus as claimed in claim 1, wherein the control means is provided with a control map previously defining an optimum current value in correspondence to various combinations between the vehicle speed value and the torque value.

4. A motor-driven steering assist apparatus as claimed in claim 2, wherein the control means is provided with a control map previously defining an optimum current value in correspondence to various combinations between the vehicle speed value and the torque value.

5. A motor-driven steering assist apparatus as claimed in claim 1, wherein the engine rotation sensor outputs a rotation pulse serving as the rotation signal per a fixed angle of crank rotation of the engine.

6. A motor-driven steering assist apparatus as claimed in claim 3, wherein the vehicle speed value constituting the control map is made in multiple stages comprising a low vehicle speed band region, a middle vehicle speed band region and a high vehicle speed band region.

7. A motor-driven steering assist apparatus as claimed in claim 4, wherein the vehicle speed value constituting the control map is made in multiple stages comprising a low vehicle speed band region, a middle vehicle speed band region and a high vehicle speed band region.
